(19) United States
(12) Patent Application Publication
(10) Pub. No.: US 2020/0061971 A1
(43) Pub. Date: Feb. 27, 2020

(54) THREE-LAYER HIGH-STRENGTH STEEL OR BALLISTIC STEEL, METHOD FOR PRODUCING A COMPONENT, AND USE THEREOF

(71) Applicants: ThyssenKrupp Steel Europe AG, Duisburg (DE); thyssenkrupp AG, Essen (DE)

(72) Inventors: Vanessa WOLSKE, Dortmund (DE); Gabriele VIDRICH-FERKEL, Muhlheim an der Ruhr (DE); Thorsten KRENKE, Duisburg (DE); Rainer FECHTE-HEINEN, Bottrop (DE); Jens-Ulrik BECKER, Duisburg (DE); Stefan MYSLOWICKI, Monchengladbach (DE)

(73) Assignees: ThyssenKrupp Steel Europe AG, Duisburg (DE); thyssenkrupp AG, Essen (DE)

(21) Appl. No.: 16/611,637

(22) PCT Filed: May 3, 2018
(86) PCT No.: PCT/EP2018/061341

§ 371 Date: Nov. 7, 2019

(30) Foreign Application Priority Data
May 16, 2017 (DE) 10 2017 208 252.6

(51) Int. Cl. B32B 15/01; B22D 11/00; C21D 8/02; C22C 38/00; C22C 38/02; C22C 38/04; C22C 38/06; C22C 38/08; C22C 38/10; C22C 38/12; C22C 38/14; C22C 38/16; C22C 38/32; F41H 5/04

(52) U.S. Cl. CPC B32B 15/011; B32B 2311/30; B22D 11/008; C21D 8/0205; C21D 8/0263; C22C 38/001; C22C 38/008; C22C 38/02; C22C 38/04; C22C 38/06; C22C 38/08; C22C 38/10; C22C 38/12; C22C 38/14; C22C 38/16; C22C 38/32; F41H 5/045; C21D 2251/02; B32B 2250/03; B32B 2250/40; B32B 2255/06; B32B 2255/205; B22D 11/007

(57) ABSTRACT

The invention relates to a three-layer wear-resistant steel or ballistic steel. The invention further relates to a process for producing a component from the wear-resistant steel or ballistic steel and also a corresponding use.

### TECHNICAL FIELD

The invention relates to a three-layer wear-resistant steel or ballistic steel. The invention further relates to a process for producing a component from the wear-resistant steel or ballistic steel and also a corresponding use.

### TECHNICAL BACKGROUND

The wear-resistant steels and ballistic steels known from the prior art are hardened to hardnesses of 350 HBW and more for their intended use and accordingly have a high strength in combination with a restricted ductility. The high hardness required in the case of a ballistic steel aims at a high penetration resistance in respect of an impinging projectile, with the diameter of the projectile widening after impact, as a result of which energy is dissipated and the penetration depth is minimized. The high hardness required in the case of a wear-resistant steel aims at a sufficiently high resistance to abrasive wear.

Wear-resistant steels and ballistic steels having a high hardness generally have only limited formability and, for example, at a hardness of 500 HB have a minimum bending ratio of about r/t=6, where r is the internal radius of the bent part on bending the steel and t is the thickness of the material of the steel/part. The bendability of the steel worsens with increasing hardness and a bending ratio r/t<6 is not possible and the further processing of the steel, in particular to form components, is greatly impaired or restricted thereby. In the case of conventional, monolithic, wear-resistant and ballistic steels having high hardnesses, a bending ratio r/t=6 leads to elongation of the peripheral lines of about 10%, so that the typical elongation at break of steels of the type in question, which is A₈₀<10%, is exceeded locally. As a result, it cannot be ruled out that microcracks/cracks or incipient cracks arise in the surface or in the region close to the surface of the steel during shaping/forming of the steel, as a function of the geometry or complexity to be produced, and/or during further stressing, and these cracks/incipient cracks can even lead to complete failure of the component because of the low ductility.

### SUMMARY OF THE INVENTION

It is an object of the present invention to provide a wear-resistant steel or ballistic steel having substantially improved properties which, in particular, has no tendency, or only a relatively low tendency, to form cracks during shaping combined with improved bendability, and also to indicate a process for producing a component and a corresponding use.

This object is achieved by a wear-resistant steel or ballistic steel having the features of claim 1.

The inventors have established that the provision of two covering layers made of a steel which is softer than the core layer, where the covering layers have a hardness which is at least 20% lower, in particular at least 50% lower, than the core layer in the hardened or tempered state, which covering layers are joined by substance-to-substance bonding to a core layer composed of a steel which in the hardened or tempered state has a hardness of >350 HBW, in particular >400 HBW, preferably >450 HBW, more preferably >500 HBW, even more preferably >550 HBW, particularly preferably >600 HBW, makes it possible to provide a three-layer ballistic steel or wear-resistant steel having improved bendability. It has surprisingly been found that the bending radii r (internal radius) which are critical in the case of comparable monolithic steels, which are dependent on the material thicknesses t and are determined by the relationship r/t, can be reduced by at least 10% by means of the covering layers applied. The hardness of the softer steel is <400 HBW, in particular <350 HBW, preferably <300 HBW, particularly preferably <250 HBW, more preferably <200 HBW. The materials composite of the invention is subjected to a heat treatment to effect hardening or tempering before its intended use, with the heat treatment being designed for the core layer. The hardness of the covering layers is preferably determined in the state after this heat treatment.

HBW corresponds to the Brinell hardness and is determined in accordance with DIN EN ISO 6506-1. What is understood by those skilled in the art under “hardening” and “tempering” is regulated in DIN EN 10052:1993.

According to the invention, the covering layers function merely as forming/bending aids and do not perform any function in a later application or during use. A soft steel alone is in principle not suitable for the application under consideration or for the use under consideration since the required functional properties, in particular a high hardness, cannot be achieved. Both in the case of a wear stress and also in the event of an impact stress, e.g. by bombardment or explosion, the soft steel alloy is substantially penetrated without offering resistance. A wear-resistant steel or ballistic steel according to the invention has to have a core layer whose thickness corresponds to a comparable monolithic steel in order to ensure comparable strength in a wear situation or a comparable bombardment resistance. The wear-resistant steel or ballistic steel of the invention is designed for the same application with a slightly greater thickness than a comparable monolithic steel, since the covering layers have to be disregarded functionally for the intended use. Studies have shown that at the same bending radius there is a greater elongation in the peripheral line of the core layer or a greater elongation at the transition between core and covering layer because of the greater thickness of the wear-resistant steel or ballistic steel of the invention compared to monolithic steel, so that early failure of the hard core layer would have been expected, but this surprisingly did not occur.

One explanation for this is that, owing to the lower hardness, the significantly greater ductility and lower yield strength of the covering layers compared to the core layer, the covering layers react with plastic deformation on bending before the core layer reaches its yield strength. The plasticization of the covering layers results, in particular, in a decrease in the stress peaks which in the case of a monolithic, hard steel would have led to failure because of the process-related surface roughness. A typical crack initiation at local, roughness-related micronotches is avoided by means of the covering layers, with achievable bending radii being able to be reduced to the above-described extent.

The covering layers of the materials composite of the invention are very quickly removed by contact with abrasive media when used, for example, in an abrasive environment until the abrasive medium comes to the exposed hard core layer of the wear-resistant steel which then analogously assumes the function of a comparable, monolithic wear-resistant steel. In the case of the ballistic steel of the invention, the covering layer remains permanently on the later component but is, for example, penetrated in the case of projectile impact without resistance or with low resistance, as a result of which the performance of the component does not change.

The ballistic steel or wear-resistant steel can be configured or passed to further processing in strip, plate or sheet form.

The core layer has a predominantly martensitic and/or bainitic microstructure. Martensite, tempered martensite and/or bainite (less preferred) is present in an amount of at least 70% by area, in particular at least 80% by area, preferably at least 85% by area, more preferably at least 90% by area, particularly preferably at least 95% by area. As a result of the method of production, the formation of the less desirable microstructural constituents ferrite, residual austenite, perlite or cementite cannot always be reliably avoided. In an alternative embodiment of the core layer, up to 30% by area of more ductile phases such as residual austenite or ferrite can also be deliberately incorporated in order to increase the ductility. In order to make the decrease in hardness associated therewith as small as possible, the proportion of these phases is preferably set to not more than 20% by area, particularly preferably not more than 10% by area. An increased ductility is particularly advantageous when a component composed of the wear-resistant steel of the invention experiences an impact wear stress or when a component composed of the ballistic steel of the invention is also to be designed to resist explosion. In a further alternative embodiment, a small proportion of not more than 10% by area, particularly preferably not more than 5% by area, of cementite and/or perlite can be incorporated in the microstructure. The high hardness of these phases can, for example, be used in the wear-resistant steel according to the invention so that, in the event of abrasive wear, hard particles project at the surface after the surrounding material has been removed by wear. These projecting particles then reduce the effective contact area between wear-resistant steel and abrasive material and thus slow the progress of wear.

According to the invention, the core layer consists of, in addition to Fe and production-related unavoidable impurities, in percent by weight, C: from 0.1 to 0.6%, optionally N: from 0.003 to 0.01%, optionally Si: from 0.05 to 1.5%, Mn: from 0.1 to 2.5%, optionally Al: from 0.01 to 2.0%, optionally Cr: from 0.05 to 1.5%, optionally B: from 0.0001 to 0.01%, optionally one or more elements from the group consisting of Nb, Ti, V and W: in total from 0.005 to 0.2%, optionally Mo: from 0.1 to 1.0%, optionally Cu: from 0.05 to 0.5%, optionally P: from 0.005 to 0.15%, S: up to 0.03%, optionally Ca: from 0.0015 to 0.015%, optionally Ni: from 0.1 to 5.0%, Sn: up to 0.05%, As: up to 0.02%, Co: up to 0.02%, 0: up to 0.005%, H: up to 0.001%, where the alloying elements N, Si, Al, Cr, B, Ti, Nb, V, W, Mo, Cu, P, Ca, Ni indicated as optional can alternatively also be present as impurity in relatively small amounts.

C is a strength-increasing alloying element and with increasing content contributes to an increase in hardness by either being present in dissolved form as interstitial atom in austenite and on cooling contributing to the formation of harder martensite or together with Fe, Cr, Ti, Nb, V or W forming carbides which firstly can be harder than the surrounding matrix or can distort these at least to such an extent that the hardness of the matrix increases. C is therefore present in contents of at least 0.1% by weight, in particular at least 0.15% by weight, preferably at least 0.2% by weight, in order to achieve or set the desired hardness. The brittleness also increases with increasing hardness, so that the content is restricted to not more than 0.6% by weight, in particular not more than 0.55% by weight, preferably not more than 0.5% by weight, more preferably not more than 0.45% by weight, particularly preferably not more than 0.4% by weight, in order not to have an adverse effect on the materials properties, in particular the ductility, and to ensure a satisfactory weldability.

N can be used as alloying element, optionally with a minimum content of 0.003% by weight, with a similar effect to C since its ability to form nitride has a positive effect on the strength. In the presence of Al, aluminum nitrides are formed and these improve nucleation and hinder grain growth. In addition, nitrogen increases the hardness of the martensite formed during hardening. The nitrogen content for the melt analysis is limited to 0.01% by weight. Preference is given to a maximum content of 0.008% by weight, particularly preferably 0.006% by weight, in order to avoid the undesirable formation of coarse titanium nitrides which would have an adverse effect on the toughness. In addition, if the optional alloying element boron is used, this is bound by nitrogen if the aluminum or titanium content is not high enough.

Si is an alloying element which contributes to mixed crystal hardening and, depending on its content, has a positive effect in increasing hardness, so that a content of at least 0.05% by weight is optionally present. At lower contents, an effectiveness of Si is not clearly detectable, but Si does not have an adverse effect on the properties of the steel. If too much silicon is added to the steel, this has an adverse effect on the weldability, the deformation capability and the toughness properties. The alloying element is therefore restricted to not more than 1.5% by weight, in particular not more than 0.9% by weight, in order to ensure sufficient rollability, and is also preferably restricted to not more than 0.5% by weight in order to reliably avoid the formation of red scale which in excessively large proportions can reduce adhesion of the interface between core layer and covering layer in the composite. In addition, Si can be used for deoxidizing the steel if the use of, for example, Al is to be avoided in order to avoid undesirable bonding of, for example, N.

Mn is an alloying element which contributes to the hardenability and is, in particular, used for binding S as MnS, so that a content of at least 0.1% by weight, in particular at least 0.3% by weight, is present. Manganese decreases the critical cooling rate, as a result of which the hardenability is increased. The alloying element is to not more than 2.5% by weight, in particular not more than 1.9% by weight, in order to ensure satisfactory weldability and good forming behavior. In addition, Mn has a strong segregating effect and is therefore preferably restricted to not more than 1.5% by weight.

Al contributes, in particular, to deoxidation, for which reason a content of at least 0.01% by weight, in particular at least 0.015% by weight, is optionally set. The alloying element is restricted to not more than 2.0% by weight, in particular not more than 1.0% by weight, to ensure very good castability, preferably to not more than 0.5% by weight, particularly preferably not more than 0.1% by weight, in order to significantly reduce and/or avoid undesirable precipitates, particularly in the form of nonmetallic oxidic inclusions, in the material, which can have an adverse effect on the materials properties. For example, the content is set in the range from 0.02 to 0.06% by weight. Al can also be used for binding nitrogen present in the steel, so that the optionally added boron can display its strength-increasing effect. In an alternative embodiment, aluminum can be alloyed in deliberately in an amount of from >1.0% by weight to 2.0% by weight in order to at least partly compensate for the weight increase of the covering layer additionally to be applied by reducing the density.

Cr as optional alloying element can, depending on the content, also contribute to setting the strength, in particular contribute positively to the hardenability, with a content of, in particular, at least 0.05% by weight. In addition, Cr can be used, either alone or in combination with other elements, as carbide former. Owing to the positive effect on the toughness of the material, the proportion of Cr can preferably be set to at least 0.1% by weight, particularly preferably at least 0.2% by weight. The alloying element is for economic reasons restricted to not more than 1.5% by weight, in particular not more than 1.2% by weight, preferably not more than 1.0% by weight, in order to ensure satisfactory weldability.

B as optional alloying element can in atomic form delay the microstructural transformation to ferrite/bainite and improve the hardenability and strength, particularly when N is bound by strong nitride formers such as Al or Nb and can be present with a content of, in particular, at least 0.0001% by weight. The alloying element is restricted to not more than 0.01% by weight, in particular not more than 0.005% by weight, since higher contents can have adverse effects on the materials properties, in particular in respect of the ductility at grain boundaries, and would result in a reduction in the hardness and/or strength.

Ti, Nb, V and/or W can be added as optional alloying elements, either individually or in combination, to effect grain refinement; in addition, Ti can be used for bonding N. However, these elements can first and foremost be used as microalloying elements in order to form strength-increasing carbides, nitrides and/or carbonitrides. To ensure their effectiveness, Ti, Nb, V and/or W can be used with contents of at least 0.005% by weight. To bring about complete binding of N, the content of Ti would have to be at least 3.42*N. The alloying elements in combination are restricted to not more than 0.2% by weight, in particular not more than 0.15% by weight, preferably not more than 0.1% by weight, since higher contents have disadvantageous effects on the materials properties, in particular have an adverse effect on the toughness of the material.

Mo can optionally be alloyed-in in order to increase the strength and improve the through-hardenability. Furthermore, Mo has a positive effect on the toughness properties. Mo can be used as carbide former to increase the yield strength and improve the toughness. In order to ensure the effectiveness of these effects, a content of at least 0.1% by weight, preferably at least 0.2% by weight, is necessary. For cost reasons, the maximum content is restricted to 1% by weight, preferably 0.7% by weight.

Cu as optional alloying element can, at a content of from 0.05% by weight to 0.5% by weight, contribute to an increasing hardness by precipitation hardening.

P is an accompanying element of iron which has a strongly toughness-reducing effect and is considered to be among the undesirable accompanying elements in wear-resistant or ballistic steels. In order to utilize its strength-increasing action, it can optionally be alloyed-in in amounts of at least 0.005% by weight. Owing to its low diffusion rate during solidification of the melt, P can lead to strong segregations. For these reasons, the element is limited to not more than 0.15% by weight, in particular not more than 0.06% by weight, preferably not more than 0.03% by weight.

S has a strong tendency to produce segregation in the steel and forms undesirable FeS, for which reason it has to be bound by means of Mn. The S content is therefore restricted to not more than 0.03% by weight, in particular 0.02% by weight, preferably 0.01% by weight, particularly preferably 0.005% by weight.

Ca can optionally be added to the melt in contents of up to 0.015% by weight, preferably up to 0.005% by weight, as desulfurizing agent and for influencing sulfide in a targeted manner, but this leads to altered plasticity of the sulfides during hot rolling. In addition, the cold forming behavior is preferably also improved by the addition of calcium. The effects described are effective at and above contents of 0.0015% by weight, for which reason this limit is selected as minimum when Ca is used.

Ni, which can optionally be alloyed-in in an amount of not more than 5.0% by weight, has a positive influence on the deformability of the material. In addition, nickel increases the through-hardening and through-tempering by reducing the critical cooling rate. For cost reasons, contents of not more than 1.5% by weight, particularly preferably not more than 1.0% by weight, are preferably set. The effects described appear at contents of 0.1% by weight and above. A content of at least 0.2% by weight is preferably alloyed-in.

Sn, As and/or Co are alloying elements which can, either individually or in combination, be counted among the impurities if they are not deliberately alloyed-in to set specific properties. The contents are restricted to not more than 0.05% by weight of Sn, not more than 0.02% by weight of Co, not more than 0.02% by weight of As.

O is usually undesirable, but can also be necessary in very small contents for the purposes of the present invention since oxide coatings, in particular on the boundary layer between core layer and covering layer, prevent diffusion between the deliberately differently alloyed steels, as described, for example, in the document DE 10 2016 204 567.9. The maximum content of oxygen is indicated as 0.005% by weight, preferably 0.002% by weight.

H as smallest atom is very mobile on interstitial sites in the steel and can, especially in very high-strength steels, lead to tearing in the core during cooling from hot rolling. The element hydrogen is therefore brought down to a content of not more than 0.001% by weight, in particular not more than 0.0006% by weight, preferably not more than 0.0004% by weight, more preferably not more than 0.0002% by weight.

As illustrative representatives for the core layer of the wear-resistant steel of the invention, it is possible to use commercial steels which are, for example, marketed by the applicant under the trade name “XAR®”, in particular XAR® 400, 450, 500, 600 and 650. As illustrative representatives for the core layer of the ballistic steel of the invention, it is possible to use commercial steels which are, for example, marketed by the applicant under the trade name “SECURE”, in particular SECURE 400, 450, 500, 600 and 650.

The covering layers for providing the bending/forming aid consist of a soft, ductile steel which can be formed easily and has, in particular, a high elongation at break. In addition, the steel for the covering layers is selected so that it has a very low hardenability. Suitable steels for the wear-resistant and ballistic steels of the invention have been found to be, in particular, microalloyed steels and also preferably soft steels having a low carbon content (ULC=“ultra-low-carbon” steels) and particularly preferably IF steels. IF (“interstitial free”) steels are alloyed so that in particular nitrogen and carbon are completely bound by elements such as Ti, Nb, V, W and/or Cr.

According to the invention, the covering layers consist of, in addition to Fe and production-related unavoidable impurities, in % by weight, C: from 0.001 to 0.15%, optionally N: from 0.001 to 0.01%, optionally Si: from 0.03 to 0.7%, optionally Mn: from 0.05 to 2.5%, optionally P: from 0.005 to 0.1%, optionally Mo: from 0.05 to 0.45%, optionally Cr: from 0.1 to 0.75%, optionally Cu: from 0.05 to 0.75%, optionally Ni: from 0.05 to 0.5%, optionally Al: from 0.005 to 0.5%, optionally B: from 0.0001 to 0.01%, optionally one or more elements selected from the group consisting of Nb, Ti, V and W: from 0.001 to 0.3%, S: up to 0.03%, optionally Ca: from 0.0015 to 0.015%, Sn: up to 0.05%, As: up to 0.02%, Co: up to 0.02%, H: up to 0.001%, 0: up to 0.005%, where the alloying elements N, Si, Mn, Al, Cr, B, Ti, Nb, V, W, Mo, Cu, P, Ca, Ni indicated as optional can alternatively be present as impurity in smaller amounts.

To increase the ductility and reduce the hardenability of the covering layer, C as alloying element is restricted to not more than 0.15% by weight, in particular not more than 0.10% by weight, preferably not more than 0.06% by weight. In a preferred embodiment, the covering layer is a ULC steel in which the maximum carbon content is restricted to 0.03% by weight. In a particularly preferred embodiment, IF steels for which a C content of not more than 0.01% by weight is prescribed are used as covering layer. In order to ensure the complete binding of C by Ti, Nb, V, W, Cr and/or Mo required in IF steels without having to set excessively high contents of Ti, Nb, V, W, Cr and/or Mo, a maximum content of 0.005% by weight, particularly preferably 0.003% by weight, is preferably set. A minimum content of C cannot be economically avoided due to the process. For this reason, the lower limit for the C content is given as 0.001% by weight.

N as optional alloying element in dissolved form likewise increases the hardenability of the steel, but can optionally also be used deliberately for nitride or carbonitride formation with Al, B, Ti, Nb, V, W, Cr and/or Mo. In order to avoid an excessive increase in the hardening of the covering layer in the manufacturing process and also embrittlement of the covering layer, the nitrogen content is restricted to not more than 0.01% by weight, preferably 0.005% by weight. Due to the process, a minimal content of N cannot be avoided economically. The optional lower limit for the N content is therefore given as 0.001% by weight.

Si, Mn, P, Mo, Cr, Cu and Ni are optional alloying elements which in an alternative embodiment of the inventive concept can be used for increasing the strength of the covering layer by reducing the hardness difference between core layer and covering layer and increasing the resistance of the covering layer to, for example, abrasive wear.

In order to ensure the respective effectiveness of the abovementioned optional alloying elements, their use in the covering layer is subjected to a minimum content of

0.03% by weight, preferably 0.1% by weight, particularly preferably 0.3% by weight, of Si
0.05% by weight, preferably 0.2% by weight, of Mn
0.005% by weight of P
0.05% by weight of Mo
0.1% by weight of Cr
0.05% by weight, preferably 0.2% by weight, of Cu
0.05% by weight, preferably 0.10% by weight, of Ni.

The respective maximum contents are set as follows:

0.7% by weight, preferably 0.5% by weight, of Si, in order to avoid adverse effects on the surface.
2.5% by weight, preferably 1.5% by weight, of Mn, in order not to increase the strength too greatly and to avoid undesirable effects due to Mn segregations.
0.1% by weight, preferably 0.05% by weight, of P in order not to reduce the ductility of the covering layer too greatly.
0.45% by weight, preferably 0.15% by weight of Mo; 0.75% by weight, preferably 0.40% by weight, of Cu; 0.75% by weight, preferably 0.25% by weight, particularly preferably 0.15% by weight, of Cr; 0.5% by weight, preferably 0.3% by weight, of Ni, in each case for economic reasons and also so as not to have too great an adverse effect on the weldability of the covering layer.

Mn additionally serves to bind S as MnS.

Al can optionally be used for deoxidation, with a content of at least 0.005% by weight, in particular 0.01% by weight, being able to be present. The content is restricted to not more than 0.5% by weight, in particular not more than 0.1% by weight, preferably not more than 0.05% by weight, in order not to adversely influence the materials properties.

B as optional alloying element can, in a further preferred embodiment of the present invention, contribute to the hardenability, in particular when N is bound, and can be present in an amount of, in particular, at least 0.0001% by weight, preferably 0.0005% by weight, particularly preferably 0.0010% by weight. The alloying element is restricted to not more than 0.01% by weight, in particular not more than 0.005% by weight, since higher contents have an adverse effect on the materials properties and lead to an excessive undesirable hardening of the covering layer.

Ti, Nb, V, W, Cr and Mo can be added as alloying elements either individually or in combination to effect grain refinement and/or to bind C and N, with the use of Ti, Nb and V being preferred for the stated purposes because of cost reasons. Ti, Nb and/or V can be used in amounts of at least 0.001% by weight, preferably 0.005% by weight, particularly preferably 0.01% by weight. To effect complete binding of C and N, the contents of Ti, Nb, V, W, Cr and Mo are, in the preferred embodiment, set on the basis of the stoichiometry in such a way that:

(Ti/47.9+Nb/92.9+V/50.9+W/183.8+Cr/(52*1.5)+Mo/(95.95*2)/(C/12+N/14)≥1.0. The alloying elements Ti, Nb, V and W are for economic reasons restricted to a combined amount of not more than 0.3% by weight, in particular not more than 0.2% by weight. The content of Ti+Nb+V+W is preferably restricted to not more than 0.15% by weight, particularly preferably 0.1% by weight, since higher contents have an adverse effect on the materials properties, in particular have an adverse effect on the toughness of the material. The maximum contents according to the invention of the optional alloying elements Cr and Mo have been indicated above.

S has a strong tendency to segregate in the steel and forms undesirable FeS, for which reason it has to be bound by means of Mn. The S content is therefore restricted to not more than 0.03% by weight, in particular 0.02% by weight, preferably 0.01% by weight, particularly preferably 0.005% by weight.

Ca can optionally be added to the melt as the sulfurizing agent and to influence sulfide formation in a targeted manner in contents of up to 0.015% by weight, in particular up to 0.005% by weight, which leads to altered plasticity of the sulfides during hot rolling. In addition, the cold forming behavior is preferably also improved by the addition of calcium. The effects described are effective at contents of 0.0015% by weight and above, for which reason this limit is selected as minimum in the case of the optional use of Ca.

Sn, As and/or Co are alloying elements which, either individually or in combination, may be counted as impurities if they are not deliberately alloyed-in to set specific properties. The contents are restricted to not more than 0.05% by weight of Sn, not more than 0.02% by weight of As, not more than 0.02% by weight of Co.

O is usually undesirable, but can be beneficial in very small contents for the purposes of the present invention since oxide coatings, in particular on the boundary layer between core layer and covering layer, prevent diffusion between the deliberately differently alloyed steels, as described, for example, in the document DE 10 2016 204 567.9. The maximum content of oxygen is indicated as 0.005% by weight, preferably 0.002% by weight.

H as smallest atom is very mobile on interstitial sites in the steel and can, especially in very high-strength steels, lead to tearing in the core during cooling from hot rolling. The element hydrogen is therefore brought down to a content of not more than 0.001% by weight, in particular not more than 0.0006% by weight, preferably not more than 0.0004% by weight, more preferably not more than 0.0002% by weight.

All optional alloying elements mentioned can be present as impurities in contents below the minimum value indicated without having an adverse effect in the covering layer of the wear-resistant or ballistic steels of the invention.

As illustrative representatives for the covering layers both of the wear-resistant steel of the invention and also the ballistic steel of the invention, it is possible to use commercial unalloyed steels, low alloy steels, microalloyed steels or IF steels.

In one embodiment of the wear-resistant steel or ballistic steel, the covering layers composed of the soft, ductile steel each have a thickness of the material in the range from 1% to 12%, in particular from 2% to 10%, preferably from 3% to 8%, particularly preferably 3% to 6%, per site based on the total thickness of the material of the wear-resistant steel or ballistic steel. The total thickness of the material is in the range from 2.0 to 40.0 mm, in particular from 3.0 to 30.0 mm and preferably from 6.0 to 20.0 mm. Depending on the use, the wear-resistant steel or ballistic steel can have a symmetrical or unsymmetrical structure in respect of the indicated proportions of covering layers.

In one embodiment, the wear-resistant steel or ballistic steel has a metallic anticorrosion coating, in particular one based on zinc, on one or both sides. The wear-resistant steel or ballistic steel is, depending on the configuration, particularly preferably provided on one or both sides with an electrolytic zinc coating. Carrying out electrolytic coating has the advantage that the properties, in particular of the core layer, are not altered in an adverse way by, in particular, thermal influences as occur, for example, in carrying out hot dip coating. As an alternative or in addition, the wear-resistant steel or ballistic steel can be provided on one or both sides with an organic coating, preferably a paint or varnish. Wear-resistant steels or ballistic steels having an improved surface coating appearance can be provided in this way.

In a further embodiment of the wear-resistant steel or ballistic steel, the wear-resistant steel or ballistic steel is produced by means of cladding, in particular rolling cladding, or by means of casting. The wear-resistant steel or ballistic steel of the invention is preferably produced by means of hot rolling cladding, as is described, for example, in the German patent document DE 10 2005 006 606 B3. Reference is made to this patent document, the contents of which are hereby incorporated into this patent application, with the manufacturing step of reeling up to give a coil being able to be regarded as optional process step. In an alternative embodiment of the process for producing the material composite of the invention, in particular in the case of thicknesses above about 10 mm, this is carried out entirely in plate or sheet form. An additional contribution to retarding crack initiation can be provided by the diffusion processes between core layer and covering layers which proceed during the hot rolling cladding which is preferably carried out, since a type of peripheral decarburization in the core layer takes place in the interfacial region of the core layer by migration of carbon from the core layer into the covering layers, which locally forms a region which is more ductile than the remaining region of the core layer. In addition, an essentially continuous rather than stepwise transition in the materials properties (hardness/strength) between the core layer and the covering layers is established as a result of the diffusion processes. The covering layers advantageously have a reduced shape change resistance in the hot state compared to the core layer as a result of the higher ductility, so that during hot rolling cladding or hot rolling they deform in the direction of the core layer and can thereby close, in particular, production-related defects, for example air inclusions between the layers, by means of the joining by rolling. This is advantageous first and foremost in later use, so that pull-outs in the case of wear stress or undesirable shockwave fractures in the case of impact stress cannot occur because of the defects. As an alternative, the wear-resistant steel or ballistic steel of the invention can be produced by means of casting, with a possible way of producing it being disclosed in the Japanese first publication JP-A 03 133 630. The production of the metallic composite is generally prior art.

To set the materials properties of the core layer required for use as wear-resistant or ballistic steel, the materials composite of the invention is hardened by accelerated cooling. The accelerated cooling takes place, in a preferred embodiment, immediately after hot rolling cladding or hot rolling without prior cooling from the rolling temperature. Cooling is stopped at a temperature below the martensite start temperature Ms of the core layer, preferably below the martensite finish temperature Mf of the core layer, particularly preferably not more than 100° C. above room temperature.

In an alternative, likewise preferred embodiment, hardening can also take place as follows: after hot rolling, the material firstly cools to temperatures below 500° C. in order to avoid undesirable effects such as grain growth or coarsening of precipitates. Cooling can take place both in the coil or as plate in air or else by contact with a cooling medium such as water or oil. For logistic reasons, cooling to below 100° C. is preferred, particularly preferably to a temperature close to room temperature. The materials composite is subsequently at least partially austenitized and for this purpose heated to a temperature at least above A_{c1} of the core layer. Preference is given to complete austenitizing and accordingly heating to at least A_{c3} of the core layer being carried out. For energy reasons, the austenitizing temperature is restricted to not more than 1100° C. in order to avoid undesirable austenite grain growth, preferably to not more than (Ac3+200° C.), particularly preferably to not more than (Ac3+100° C.), with A_{c3} in each case relating to the core layer.

Subsequent to heating, the materials composite is subjected to accelerated cooling to a temperature of less than 500° C., preferably less than 300° C., particularly preferably less than 100° C., to effect hardening. To increase the ductility, the materials composite can subsequently be annealed, with temperature and duration of the annealing treatment being selected according to the alloy of the core layer and the desired annealing effect. The processes for the annealing treatment correspond to the usual procedures disclosed in the prior art for single-layer materials for an alloy concept which corresponds to the respective core layer of the materials composite of the invention.

Between the production steps hot rolling cladding, hot rolling, hardening and annealing, the materials composite can, for logistic reasons, optionally be rolled up to form a coil and wound off again in preparation for the next production step.

According to a second aspect, the invention provides a process for producing a component having a ballistic protective action, wherein a ballistic steel according to the invention is cold formed. Since the covering layers of the ballistic steel of the invention are particularly readily deformable, optimal bending properties, in particular in the peripheral line, are present and the ballistic steel of the invention can be shaped with a smaller bending radius compared to a monolithic ballistic steel having the same composition. The component produced is used for protecting living beings in vehicles or buildings.

According to a third aspect, the invention provides a process for producing a component which is to be subjected to high abrasive wear, wherein a wear-resistant steel according to the invention is cold formed. Since the covering layers of the ballistic steel of the invention are particularly readily deformable, optimal bending properties are present and the wear-resistant steel of the invention can be shaped with a smaller bending radius compared to a monolithic wear-resistant steel having the same composition. The component produced is used in construction, agricultural, mining or transport machines, especially in dump trucks.

### BRIEF DESCRIPTION OF THE DRAWING

The invention will be illustrated below with the aid of a drawing depicting a working example. The drawing shows

FIG. 1) a schematic section through a wear-resistant steel or ballistic steel according to the invention.

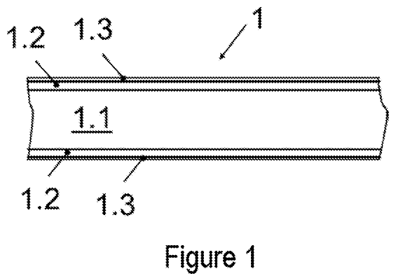

### DESCRIPTION OF PREFERRED EMBODIMENTS

The single FIGURE shows a schematic sectional view through a wear-resistant steel or ballistic steel (1) according to the invention. The three-layer wear-resistant steel or ballistic steel (1) according to the invention comprises a core layer (1.1) composed of a steel which in the hardened or tempered state has a hardness of >350 HBW, in particular >400 HBW, preferably >500 HBW, more preferably >550 HBW, particularly preferably >600 HBW, and two covering layers (1.2) composed of a softer steel which are joined by substance-to-substance bonding to the core layer (1.1), where the covering layers (1.2) have a hardness which is at least 20% lower than that of the core layer (1.1) in the hardened or tempered state, with a hardness of <400 HBW, in particular <350 HBW, preferably <300 HBW, particularly preferably <250 HBW, more preferably <200 HBW. The wear-resistant steel or ballistic steel (1) can have a metallic anticorrosion coating (1.3) on both sides.

The core layer (1.1) consists of, in addition to Fe and production-related unavoidable impurities, in % by weight, C: from 0.1 to 0.6%, optionally N: from 0.003 to 0.01%, optionally Si: from 0.05 to 1.5%, Mn: from 0.1 to 2.5%, optionally Al: from 0.01 to 2.0%, optionally Cr: from 0.05 to 1.5%, optionally B: from 0.0001 to 0.01%, optionally one or more elements selected from the group consisting of Nb, Ti, V and W: in total from 0.005 to 0.2%, optionally Mo: from 0.1 to 1.0%, optionally Cu: from 0.05 to 0.5%, optionally P: from 0.005 to 0.15%, S: up to 0.03%, optionally Ca: from 0.0015 to 0.015%, optionally Ni: from 0.1 to 5.0%, Sn: up to 0.05%, As: up to 0.02%, Co: up to 0.02%, 0: up to 0.005%, H: up to 0.001%.

The covering layers (1.2) consist of, in addition to Fe and production-related unavoidable impurities, in % by weight, C: from 0.001 to 0.15%, optionally N: from 0.001 to 0.01%, optionally Si: from 0.03 to 0.7%, optionally Mn: from 0.05 to 2.5%, optionally P: from 0.005 to 0.1%, optionally Mo: from 0.05 to 0.45%, optionally Cr: from 0.1 to 0.75%, optionally Cu: from 0.05 to 0.75%, optionally Ni: from 0.05 to 0.5%, optionally Al: from 0.005 to 0.5%, optionally B: from 0.0001 to 0.01%, optionally one or more elements selected from the group consisting of Nb, Ti, V and W: from 0.001 to 0.3%, S: up to 0.03%, optionally Ca: from 0.0015 to 0.015%, Sn: up to 0.05%, As: up to 0.02%, Co: up to 0.02%, H: up to 0.001%, 0: up to 0.005%.

The thickness of the materials of the covering layers (1.2) can be in the range from 1% to 12%, in particular from 2% to 10%, preferably from 3% to 8%, per side based on the total thickness of materials of the wear-resistant steel or ballistic steel (1).

A ballistic steel according to the invention and a wear-resistant steel according to the invention were produced from commercial flat steel products by means of hot rolling cladding, each of which had a three-layer materials composite. A microalloyed steel having the designation S315MC or an IF steel having the designation DC05 was in each case used as covering layers and a steel having the designation XAR® 500 or XAR® 600 was used as core layer for producing the wear-resistant steel and a steel having the designation SECURE500 or SECURE600 or SECURE 650 was used as core layer for producing the ballistic steel. The covering layers each had a thickness of material of 10% per side based on the total thickness of material of the wear-resistant steel; the thicknesses of materials of the covering layers of the ballistic steel, on the other hand, were in each case 5% per side based on the total thickness of material of the ballistic steel. Both the ballistic steel and also the wear-resistant steel were in all indicated variants of the core layer in each case combined with all indicated variants of the covering layer.

Pieces of sheet which had been cut to size, comprising two covering layers and a core layer arranged in between, were in each case stacked on top of one another and were joined at least in regions along their edges by substance-to-substance bonding, preferably by means of welding, to give a precomposite. The precomposite was brought to a temperature of >1100° C. and hot rolled in a number of steps to give a materials composite having a total thickness of material of 6 mm. The materials composite was subsequently electrolytically coated on both sides with a zinc-based coating having a layer thickness of 20 μm in each case. The layer thicknesses can be in the range from 5 to 30 μm.

Plates were parted from the materials composites produced. In addition to the materials composites, monolithic plates of each of the designations indicated were also produced from the same melt as the core layers. Here, the thicknesses of material in the case of the ballistic steels were 5.4 mm, which corresponded to the core layer thickness of the ballistic steels according to the invention. In the case of the wear-resistant steels, monolithic plates having a thickness of material of 4.8 mm corresponding to the core layer thickness of the wear-resistant steels according to the invention, were in each case produced. The monolithic plates were each provided as reference.

All plates, which had a size of 6000 mm×1200 mm, were heated to the austenitizing temperature, in particular above Acs based on the core layer, in a furnace for in each case about 180 minutes and heated through and were subsequently quenched in order to set the desired hardness in the core layer. Before quenching, the plates were clamped in a cooling apparatus, known as a quencher, in order to ensure an essentially distortion-free thermal treatment. Quenching was carried out by contact with water. Other liquid media for quenching can likewise be used. The cooling rates in the core of the materials composite were monitored by means of thermocouples introduced beforehand and were >20 K/s. Due to the process, a cooling power which is homogeneous over the entire surface of the material cannot always be achieved in quenchers since the water is supplied from spray nozzles which can produce only an approximately uniform supply of water. Locally nonuniform cooling powers can lead to undesirable property variations, for example in the hardness. Inhomogeneous cooling profiles due to the process can also lead, in the phase transformation of the material, to stresses at the surface of the monolithic materials used hitherto, which stresses are firstly undesirable for further processing since they can lead to distortion on a component to be produced during further processing, and secondly local microstructural differences can in the extreme case lead to damage to the material close to the surface, which in the production process can lead to rejects or unavoidable after-working, for example to grind out incipient cracks. It has surprisingly been found that irregularities as occur every now and again in the case of the monolithic steels used hitherto could not be found in the case of the wear-resistant steels and ballistic steels of the invention. One explanation for this could be that the soft covering layers which have very good thermal conductivity have a homogenizing effect in respect of heat removal, effectively provide a type of heat buffer or intermediate buffer, but it is at the same time ensured that the removal of heat is sufficiently high for a hardened microstructure to be able to be formed in the core layers despite the covering layer. The covering layers which perform no function in respect of the application or use therefore also lead, owing to the homogenization of the removal of heat from the core layer, to uniform hardness in the core layer and, cited therewith, to an increase in process reliability.

The core layers of the ballistic steel of the invention and of the wear-resistant steel of the invention had a microstructure composed predominantly of martensite and/or bainite, in particular mainly martensite. In the case of the covering layer S315MC, a mixed microstructure with proportions of ferrite, bainite and some martensite has been formed in the covering layers. In the case of the covering layer DC05, an essentially ferritic microstructure with small proportions of bainite and/or martensite was observed, which is attributed to carbon diffusion from the core layer. The monolithic reference steels had properties comparable to those of the corresponding core layers having the same composition.

In a bending test carried out in accordance with the publication “Sicherheitsstähle SECURE. Verarbeitungsempfehlungen.” Of ThyssenKrupp Steel AG, 08/2008 edition, the plates were bent perpendicular to the former rolling direction. The critical bending radius r in the case of the monolithic ballistic steel SECURE 500 with the cladding material DC05 was found to be about 30 mm. Tighter bending radii led to incipient cracks at the surface in the bent region. The critical bending radius r in the case of the monolithic wear-resistant steel XAR 500 with the cladding material DC05 was found to be about 23.5 mm. Tighter bending radii also led to incipient cracks at the surface in the bent region in the case of the monolithic wear-resistant steel. In the case of the ballistic steel according to the invention, bending radii down to about 27 mm were possible without discernible incipient cracks. In the case of the wear-resistant steel according to the invention, bending radii down to about 21 mm could be implemented without problems. The possibility of implementing a smaller bending radius is greater in the case of the wear-resistant steel according to the invention compared to the ballistic steel according to the invention, which is attributed to the slightly greater thickness of material of the covering layers. A reduction in the critical bending radius in the case of wear-resistant steels and ballistic steels of the invention compared to monolithic reference steels having the same properties is associated with a slight increase in weight.

The invention is not restricted to the working example depicted in the drawing or to the information given in the general description. Rather, the wear-resistant steel or ballistic steel according to the invention can also be produced from a tailored product, for example a tailored blank and/or tailored rolled blank.

1. A three-layer wear-resistant steel or ballistic steel comprising a core layer composed of a steel which in the hardened or tempered state has a hardness of >350 HBW and two covering layers which are joined by substance-to-substance bonding to the core layer and are composed of a softer steel, where the covering layers have a hardness which is at least 20% lower than that of the core layer in the hardened or tempered state, wherein the core layer comprises, in addition to Fe and production-related unavoidable impurities, in % by weight,
C: from 0.1 to 0.6%,
Mn: from 0.1 to 2.5%,
S: up to 0.03%,
Sn: up to 0.05%,
As: up to 0.02%,
Co: up to 0.02%,
O: up to 0.005%,
H: up to 0.001%,
and the covering layers comprise, in addition to Fe and production-related unavoidable impurities, in % by weight,
C: from 0.001 to 0.15%,
S: up to 0.03%,
Sn: up to 0.05%,
As: up to 0.02%,
Co: up to 0.02%,
H: up to 0.001%,
O: up to 0.005%.

2. The wear-resistant steel or ballistic steel as claimed in claim 1, wherein the covering layers have a thickness of material in the range from 1% to 12%, per side based on the total thickness of material of the wear-resistant steel or ballistic steel.

3. The wear-resistant steel or ballistic steel as claimed in claim 2 wherein the wear-resistant steel or ballistic steel has a metallic anticorrosion coating on one or both sides and/or is provided on one or both sides with an organic coating.

4. The wear-resistant steel or ballistic steel as claimed in claim 2 wherein the wear-resistant steel or ballistic steel has been produced by means of cladding or by means of casting.

5. The wear-resistant steel or ballistic steel of claim 1 wherein the ballistic steel is cold formed.

6. (canceled)

7. A process for producing a component which is to be subjected to high abrasive wear, wherein a wear-resistant steel as claimed in claim 4 is cold formed.

8. (canceled)

9. The wear-resistant steel or ballistic steel of claim 1 wherein the core layer further comprises at least one of N: from 0.003 to 0.01% and Si: from 0.05 to 1.5%.

10. The wear-resistant steel or ballistic steel of claim 1 wherein the core layer further comprises at least one of Al: from 0.01 to 2.0%, Cr: from 0.05 to 1.5%, and B: from 0.0001 to 0.01%.

11. The wear-resistant steel or ballistic steel of claim 1 wherein the core layer further comprises at least one element selected from the group comprising of Nb, Ti, V and W: in total from 0.005 to 0.2%.

12. The wear-resistant steel or ballistic steel of claim 1 wherein the core layer further comprises at least one of Ca: from 0.0015 to 0.015%, and Ni: from 0.1 to 5.0%.

13. The wear-resistant steel or ballistic steel of claim 1 wherein the covering layers further comprise at least one of N: from 0.001 to 0.01%, Si: from 0.03 to 0.7%, Mn: from 0.05 to 2.5%, P: from 0.005 to 0.1%, Mo: from 0.05 to 0.45%, Cr: from 0.1 to 0.75%, Cu: from 0.05 to 0.75%, Ni: from 0.05 to 0.5%, Al: from 0.005 to 0.5%, and B: from 0.0001 to 0.01%.

14. The wear-resistant steel or ballistic steel of claim 1 wherein the covering layers further comprise one or more elements selected from the group consisting of Nb, Ti, V and W: from 0.001 to 0.3%.

15. The wear-resistant steel or ballistic steel of claim 1 wherein the covering layers further comprise Ca: from 0.0015 to 0.015%.

16. The wear-resistant steel or ballistic steel of claim 2 wherein the covering layers have a thickness of material in the range of 2% to 10% per side.
